(19) United States
(12) Patent Application Publication
(10) Pub. No.: US 2023/0128568 A1
(43) Pub. Date: Apr. 27, 2023

(54) INFORMATION PROCESSING DEVICE, FACE AUTHENTICATION SYSTEM, AND INFORMATION PROCESSING METHOD

(71) Applicant: Panasonic Intellectual Property Management Co., Ltd., Osaka (JP)

(72) Inventors: Masao KUBOTA, Tokyo (JP); Yoshinori KUNIEDA, Tokyo (JP); Yutaka YAMAMOTO, Kanagawa (JP)

(73) Assignee: Panasonic Intellectual Property Management Co., Ltd., Osaka (JP)

(21) Appl. No.: 17/802,046

(22) PCT Filed: Feb. 25, 2021
(86) PCT No.: PCT/JP2021/006962

§ 371 Date: Aug. 24, 2022

(30) Foreign Application Priority Data
Feb. 26, 2020 (JP) 2020-030493

(51) Int. Cl. G07C 9/37; G06T 7/20; G06V 40/16

(52) U.S. Cl. CPC G07C 9/37; G06T 7/20; G06V 40/172; G06T 2207/30201; G06T 2207/30268

(57) ABSTRACT

Provided are an information processing device, a face authentication system, and an information processing method which can improve the processing speed for collation that uses a face image of a person passing through a specific area. This information processing device includes: an acquisition unit for acquiring an image that is obtained by imaging, at a first site, a person who can ride a vehicle moving to a second site from the first site; and a processing unit for determining, on the basis of information about a face image contained in the image, a candidate of a person who can reach the second site with the vehicle.

### TECHNICAL FIELD

The present disclosure relates to an information processing apparatus, a face authentication system, and an information processing method.

### BACKGROUND ART

A technique of managing, by face authentication, entry and exit of a person passing through a gate installed in a station, an airport, or the like is known. Patent Literature (hereinafter, referred to as “PTL”) 1 discloses a technique for realizing smooth passage of a person through a gate. In the technique of PTL 1, a feature value of a subject in a captured image of a region of the gate prior to passage is extracted, and collation judgement is performed based on collation information (such as information about the feature value of the person) registered in advance and the estimated distance between the person approaching the gate and the gate.

### CITATION LIST

### Patent Literature

PTL 1

Japanese Patent Application Laid-Open No. 2019-133364

### SUMMARY OF INVENTION

Since the time period for a person to pass through the gate is about several seconds, processing in a short time is expected when a person passing through the gate is collated (or authenticated) using a face image.

Non-limiting examples of the present disclosure contribute to providing an information processing apparatus, a face authentication system, and an information processing method capable of improving the processing speed of collation using a face image of a person passing through a particular region such as a gate (hereinafter, sometimes abbreviated as “face image collation” or “face image authentication”).

An information processing apparatus according to an embodiment of the present disclosure includes: an obtainer that obtains an image of a person who is able to board a vehicle that is to move from a first point to a second point, the image being captured at the first point; and a processor that determines a candidate for a person who is capable of reaching the second point by the vehicle and who is subjected to face collation at the second point, the determining being based on information on a face image included in the image.

A face authentication system according to an embodiment of the present disclosure includes: a camera that, at a first point, captures an image of a person who is able to board a vehicle that is to move from the first point to a second point; and an information processing apparatus that obtains the image captured by the camera, and determines a candidate for a person who is capable of reaching the second point by the vehicle and who is subjected to face collation at the second point, the determining being based on information on a face image included in the image.

An information processing method according to an embodiment of the present disclosure obtains an image of a person who is able to board a vehicle that is to move from a first point to a second point, the image being captured at the first point; and determines a candidate for a person who is capable of reaching the second point by the vehicle and who is subjected to face collation at the second point, the determining being based on information on a face image included in the image.

It should be noted that general or specific embodiments may be implemented as a system, an apparatus, a method, an integrated circuit, a computer program, a storage medium, or any selective combination thereof.

According to an embodiment of the present disclosure, it is possible to improve the processing speed of the face image collation of a person who passes through a particular region.

Additional benefits and advantages of the disclosed exemplary embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating an outline of functions of a face authentication system according to the present disclosure;

FIG. 2 is a diagram illustrating a configuration example of a face authentication system according to Embodiment 1;

FIG. 3 is a diagram illustrating an exemplary hardware configuration of a face authentication server and an entry face authentication apparatus;

FIG. 4 is a diagram illustrating an exemplary functional configuration of the face authentication server and a gate according to Embodiment 1;

FIG. 5 is a flowchart for explaining an exemplary operation of the face authentication system according to Embodiment 1;

FIG. 6 is a diagram illustrating an exemplary functional configuration of the face authentication server and a gate according to Embodiment 2; and

FIG. 7 is a flowchart for explaining an exemplary operation of the face authentication system according to Embodiment 2.

### DESCRIPTION OF EMBODIMENTS

Hereinafter, preferred embodiments of the present disclosure will be described in detail with reference to the appended drawings. Note that, in the present specification and drawings, components having substantially the same functions are provided with the same reference symbols, and redundant description will be omitted.

### Embodiment 1

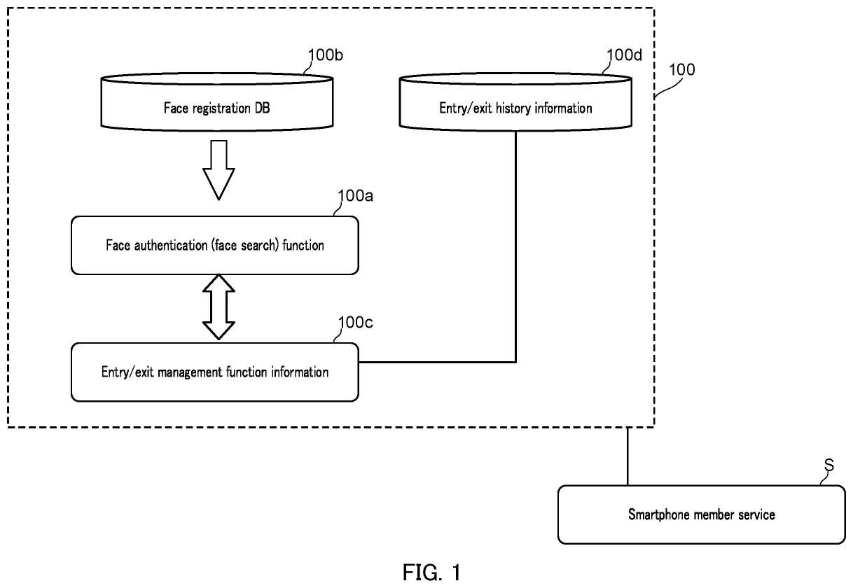

FIG. 1 is a diagram illustrating an outline of functions of face authentication system 100 according to the present disclosure. Face authentication system 100 includes face authentication (face search) function 100a, entry/exit management function 100c, and the like.

Face authentication function 100a performs face authentication by collating a face image registered in face registration database (DB) 100bwith a face image of a person passing through a gate (entry gate, exit gate, or the like) installed in a facility such as an airport, a station, or an event venue.

Face registration DB 100b stores, for example, face images captured by smartphones, ticket vending machines, and the like.

The collation is to judge, by collating the face images registered in advance with the face image of the person passing through the gate, whether or not any of the face images registered in advance matches the face image of the person passing through the gate, or whether or not any of the face images registered in advance and the face image of the person passing through the gate are face images of the same person.

Meanwhile, the authentication is to prove to the outside (e.g., to the gate) that a person of a face image matching one of the face images registered in advance is the person herself/himself (in other words, the person is a person who is allowed to pass through the gate).

However, in the present disclosure, “collation” and “authentication” may be used as mutually interchangeable terms.

Entry/exit management function 100c obtains, from entry/exit history information DB 100d, information relating to entry/exit (identification information for identifying the gate through which entry/exit is performed, the time of entry/exit through the gate, and the like), and controls an opening/closing operation of an opening/closing door mechanism in accordance with the collation result.

Further, entry/exit management function 100c transmits information on the entry/exit record to, for example, smartphone member service S. The information on the entry/exit record is, for example, the time of entry into the gate, the time of exit through the gate, and the like.

Smartphone member service S is, for example, a service for providing an entry/exit management system by face authentication. The user of the smartphone receiving this service registers face images for face authentication in face registration DB 100b by capturing an image of the user's face with cameras attached to the smartphone. For example, this service may include a service such as notifying the user of information about the entry/exit records of entry/exit through the gate.

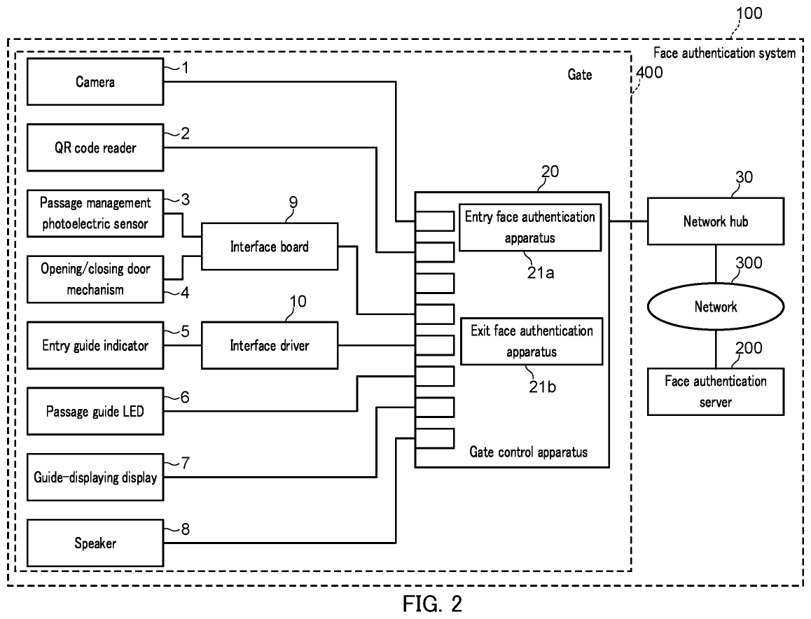

Next, a configuration example of the face authentication system will be described with reference to FIG. 2. In the following, by way of example, one example will be described in which the face authentication system is applied for entry/exit management using face authentication at a gate installed at an entrance of each station of a railway network.

FIG. 2 is a diagram illustrating a configuration example of the face authentication system according to the present embodiment. Face authentication system 100 according to the present embodiment is, for example, a system for controlling a gate (such as a ticket gate) installed at an entrance of a station. In face authentication system 100 according to the present embodiment, for example, management of entry and exit on a user who uses a facility is executed by face authentication. For example, when the user enters the facility (e.g., station premises) through a gate, it is judged by face authentication whether the user is a person permitted to enter the facility. In addition, when the user exits the facility through the gate, it is judged by face authentication whether or not the user is a person permitted to exit the facility. Note that “face authentication” may be regarded as a concept included in “collation using a face image.”

Face authentication system 100 includes gate control apparatus 20 that controls gate 400 and face authentication server 200. Face authentication system 100 also includes camera 1 for face image capturing, QR code (registered trademark) reader 2, passage management photoelectric sensor 3, opening/closing door mechanism 4, entry guide indicator 5, passage guide LED (Light Emitting Diode) 6, and guide-displaying display 7. Face authentication system 100 includes speaker 8, interface board 9, interface driver 10, network hub 30, and the like.

Gate control apparatus 20 is connected to network hub 30, and can communicate with server 200 via network hub 30 and network 300. Server 200 performs processing related to face authentication. Therefore, server 200 may be referred to as face authentication server 200. Gate control apparatus 20 is, for example, an apparatus for controlling the gate to be installed in the station. Gate control apparatus 20 controls opening/closing door mechanism 4 of gate 400. For example, gate 400 is opened for a person authorized by face authentication. On the other hand, the gate is closed for a person who fails in face authentication.

Gate control apparatus 20 includes entry face authentication apparatus 21a and exit face authentication apparatus 21b. Gate control apparatus 20 performs gate control including a gate opening/closing operation based on the outputs from entry face authentication apparatus 21a and exit face authentication apparatus 21b.

For face authentication of entry face authentication apparatus 21a and exit face authentication apparatus 21b, information on several hundreds of thousands to several tens of millions of face images, for example, is used. This information is recorded at least in face authentication server 200. Hereinafter, the information used for face authentication is sometimes referred to as “authentication information” or “collation information.” For example, the authentication information may be registered in advance in face authentication server 200 through a usage procedure by a user who will use the entry/exit management service based on face authentication.

Entry face authentication apparatus 21a and exit face authentication apparatus 21b may be disposed to be able to communicate with face authentication server 200. Entry face authentication apparatus 21a and exit face authentication apparatus 21b may be incorporated in gate control apparatus 20, or at least one of entry face authentication apparatus 21a and exit face authentication apparatus 21b may be disposed outside gate control apparatus 20. Although FIG. 2 illustrates an example in which gate 400 is for both entry and exit, gate 400 may be exclusively for entry or exclusively for exit. When gate 400 is exclusively for entry, gate control apparatus 20 does not have to include exit face authentication apparatus 21b. When gate 400 is exclusively for exit, gate control apparatus 20 does not have to include entry face authentication apparatus 21a.

Camera 1 is a camera for capturing an image of the face of a person passing through gate 400.

QR code reader 2 reads a QR code containing information identifying a person passing through the gate. For example, a person who performs entry/exit management without using face authentication among those who pass through the gate performs authentication by causing QR code reader 2 to read the QR code.

Passage management photoelectric sensor 3 detects whether or not a person comes into the gate and whether or not the person who is permitted to pass through the gate has passed through the gate. For example, passage management photoelectric sensor 3 may be disposed at a plurality of positions including a place for detecting whether or not a person comes into the gate and a place for detecting whether or not the person has passed through the gate. Passage management photoelectric sensor 3 is connected to gate control apparatus 20, for example, via interface board 9. The method for detecting a person coming into and having passed through the gate is not limited to a method using a photoelectric sensor, but can be realized by other methods such as monitoring the movement of a person in an image captured by a camera installed on a ceiling or the like. That is, the photoelectric sensor is one example as a sensor for passage management, and other sensors may be used.

Opening/closing door mechanism 4 is connected to gate control apparatus 20 via, for example, interface board 9.

Entry guide indicator 5 broadcasts whether or not passage through gate 400 is permitted. Entry guide indicator 5 is connected to a gate control apparatus 20, for example, via interface driver 10.

Passage guide LED 6 emits light in a color corresponding to the state of gate 400, for example, to inform whether or not gate 400 is in a state of allowing passage.

Guide-displaying display 7 displays, for example, information on whether passage is permitted or not.

Speaker 8 generates, for example, a sound indicating whether passage is permitted or not.

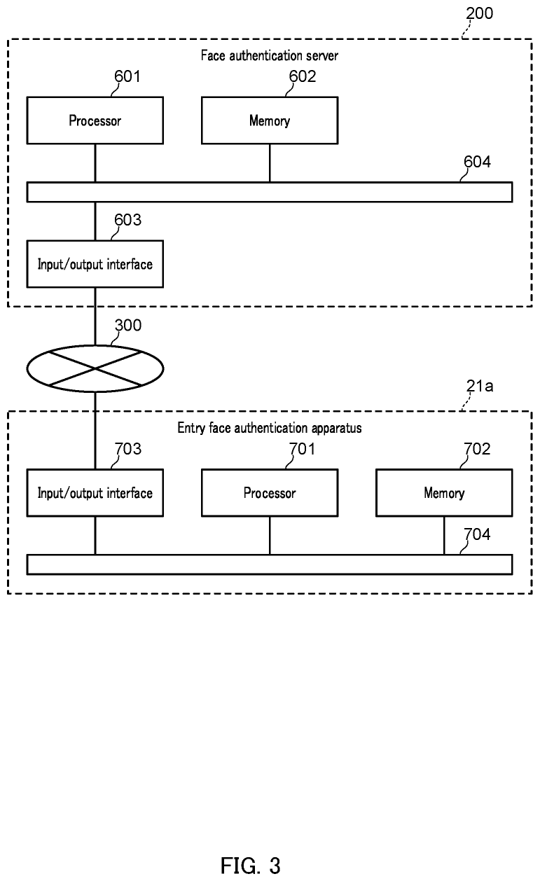

Next, a hardware configuration of face authentication server 200 and entry face authentication apparatus 21a will be described with reference to FIG. 3. Since exit face authentication apparatus 21b has the same hardware configuration as entry face authentication apparatus 21a, a description of the hardware configuration of exit face authentication apparatus 21b will be omitted. FIG. 3 is a diagram illustrating an exemplary hardware configuration of the face authentication server and the entry face authentication apparatus.

Face authentication server 200 includes processor 601, memory 602, and input/output interface 603 used for transmitting various kinds of information. Processor 601 is an arithmetic apparatus such as a Central Processing Unit (CPU) or a Graphics Processing Unit (GPU). Memory 602 is a storage apparatus implemented by using a Random Access Memory (RAM), a Read Only Memory (ROM), or the like. Processor 601, memory 602, and input/output interface 603 are connected to bus 604 and pass various kinds of information to one another through bus 604. For example, processor 601 reads programs, data, and the like stored in the ROM onto the RAM and executes the processing to implement the functions of face authentication server 200.

Entry face authentication apparatus 21a includes processor 701, memory 702, and input/output interface 703 used for transmitting various kinds of information. Processor 701 is an arithmetic apparatus such as a CPU or a GPU. Memory 702 is a storage apparatus implemented using a RAM, a ROM, or the like. Processor 701, memory 702, and input/output interface 703 are connected to bus 704 and pass various kinds of information to one another through bus 704. For example, processor 701 reads programs, data, and the like stored in the ROM onto the RAM and executes the processing to implement the functions of entry face authentication apparatus 21a.

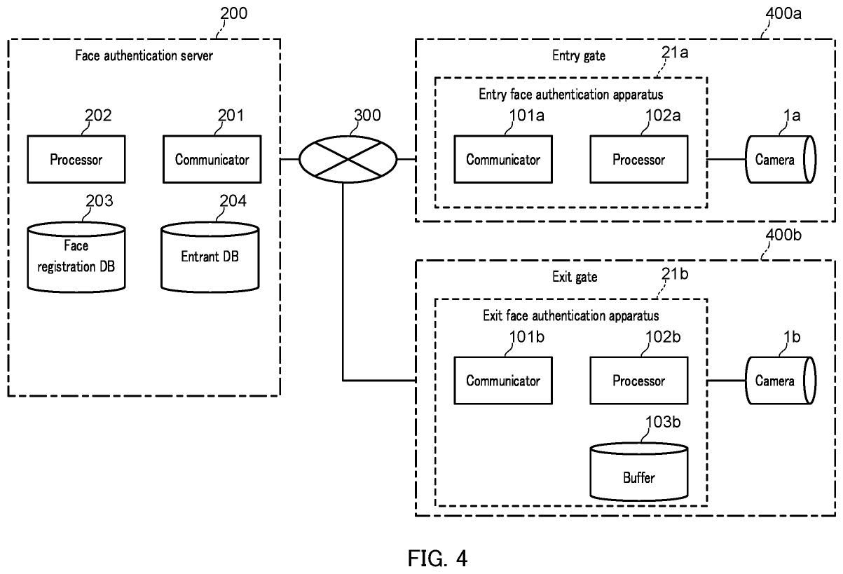

FIG. 4 is a diagram illustrating an exemplary functional configuration of the face authentication server and the gate according to present Embodiment 1. Entry gate 400a, exit gate 400b, and face authentication server 200 are connected to each other via network 300.

Entry gate 400a includes entry face authentication apparatus 21a and camera 1a.

Camera 1a captures an image of, for example, a person moving toward entry gate 400a.

Entry face authentication apparatus 21a includes communicator 101a for communicating with face authentication server 200 via network 300, and processor 102a.

Exit gate 400b includes exit face authentication apparatus 21b and camera 1b.

Camera 1b, for example, captures an image of a person moving toward exit gate 400b.

Exit face authentication apparatus 21b includes communicator 101b for communicating with face authentication server 200 via network 300, processor 102b, and buffer 103b for recording various information.

Face authentication server 200 includes communicator 201 that communicates with entry face authentication apparatus 21a and exit face authentication apparatus 21b via network 300, face registration DB 203 that manages authentication information, processor 202, and entrant DB 204. The authentication information managed by face registration DB 203 includes, for example, information on the face images of several hundreds of thousands to several tens of millions of users, and part of the authentication information corresponds to authentication information managed by entrant DB 204. In addition, the authentication information may include information on the history of movement of each registrant (entry/exit history information). The information relating to the movement history may include: for example, information relating to a past entry point (e.g., a station where a registrant entered) and entry time of entry of the registrant; an exit point (e.g., a station where the registrant exited) and exit time of exit of the registrant; and information on a commuter pass of the registrant.

Although FIG. 4 illustrates an example in which one face authentication server 200, one entry gate 400a, and one exit gate 400b are connected to network 300, the present disclosure is not limited thereto. For example, a plurality of entry gates 400a and exit gates 400b may be connected to network 300. For example, in the case of a railway network, entry gate 400a and exit gate 400b of each station may be connected to network 300. In addition, one gate 400 may have the functional configurations of both entry face authentication apparatus 21a and exit face authentication apparatus 21b illustrated in FIG. 4.

Next, an exemplary operation of face authentication server 200, entry face authentication apparatus 21a, and exit face authentication apparatus 21b according to present Embodiment 1 will be described.

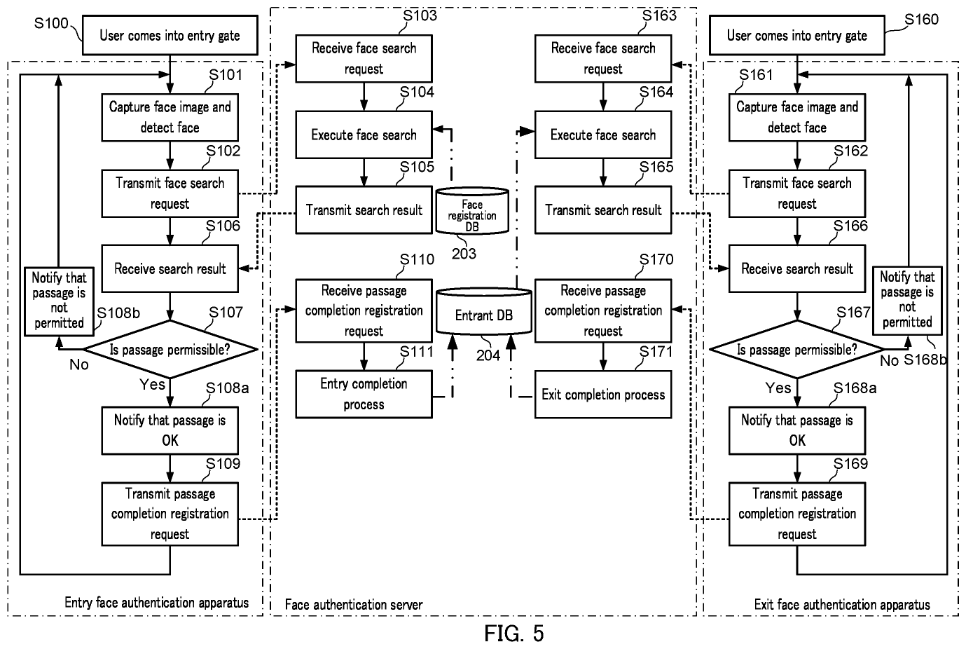

FIG. 5 is a flowchart for explaining an exemplary operation of the face authentication system according to present Embodiment 1.

Hereinafter, an example of the operation will be described in connection with entry and exit of certain user Y. In the following description, entry gate 400a refers to a gate through which user Y enters, and exit gate 400b refers to a gate through which user Y exits. Note that, present Embodiment 1 will be described by taking a railway network as an example. Entry gate 400a and exit gate 400b are disposed at each station included in the railway network. Here, the movement by train from a station where entry gate 400a is disposed to a station where exit gate 400b is disposed may correspond to the movement from entry gate 400a to exit gate 400b.

To begin with, a case where user Y enters through entry gate 400a will be described.

User Y coming into entry gate 400a (S100). Coming into entry gate 400a by user Y may be detected by, for example, passage management photoelectric sensor 3.

Camera 1a of entry gate 400a captures an image of an area including the face of user Y, and processor 102a of entry face authentication apparatus 21a detects a face region (captured face image) from the image captured by camera 1a (S101).

Processor 102a transmits a face search request to face authentication server 200 via communicator 101a (S102). The face search request may include the captured face image.

Processor 202 of face authentication server 200 receives the face search request via communicator 201 (S103).

Processor 202 of face authentication server 200 executes face search (S104). For example, processor 202 executes the face search based on a score indicating the likelihood that two face images are of the same person. For example, processor 202 calculates a score between a face image (candidate face image) in authentication information on each registrant included in face registration DB 203 and the captured face image of user Y, and judges that user Y corresponds to the person of the candidate face image having the highest score. Then, processor 202 judges whether or not user Y is a person permitted to pass through entry gate 400 based on the information on judged user Y.

Communicator 201 transmits a search result including the judgement result obtained in S104 to entry face authentication apparatus 21a (S105).

Processor 102a of entry face authentication apparatus 21a receives the search result via communicator 101a (S106). Processor 102a judges based on the received search result whether or not the passage of user Y is permitted (S107).

When the passage is permitted (Yes in S107), entry gate 400a opens a door and notifies information indicating the permission for passage (S108a). For example, the permission for passage may be notified to user Y by display by an indicator and/or by voice notification.

When the passage is not permitted (No in S107), entry gate 400a keeps the door closed and notifies information indicating that the passage is not permitted (S108b). Then, the process of S101 is executed.

Processor 102a detects the passage of user Y, and transmits, via communicator 101a, a request for registering the passage of user Y through entry gate 400a (S109). The registration request for registering the passage of the user through entry gate 400a may include the identification information (Identification (ID)) of the user who passed through entry gate 400a, the time of passage of the user, and the information on the station or gate where the passage through entry gate 400a took place.

Processor 202 of face authentication server 200 receives, via communicator 201, a passage completion registration request for registration of completion of passage by user Y (S110).

Processor 202 of face authentication server 200 executes an entry completion process regarding user Y (S111). For example, processor 202 extracts the authentication information on user Y from face registration DB 203, and stores the authentication information in entrant DB 204. The authentication information stored in entrant DB 204 is authentication information on the person who has completed entry (hereinafter, sometimes referred to as “entrant”) among the registrants. The entrant is one example of a candidate exiting person who is to exit through exit gate 400b. The candidate exiting person is one example of a candidate for a person who can reach exit gate 400b and who is to be subjected to face collation at exit gate 400b. For example, in the case of a railway network, an entrant is one example of a person who may get on (or board) a train (one example of a vehicle) moving from entry gate 400a (first point) of a certain station to exit gate 400b (second point) of another certain station. Note that, the station where the entrant enters and the station where the entrant exits may be the same.

In the following description, storing the authentication information on the entrant in entrant DB 204 may be described as generating (creating) entrant DB 204. Similarly, for other DBs to be described later, storing information in the DB may be described as creating a DB. In addition, using information stored in the DB may be abbreviated as using the DB. Also, transmitting (or receiving) information stored in the DB may be abbreviated as transmitting (or receiving) the DB. In other words, “DB” may be interpreted as a physical or virtual constituent component that stores information (or data) or as stored information (or data).

Entrant DB 204 stores authentication information on entrants through entry gates 400a of respective stations of the railway network.

Then, at each of entry gates 400a, the processes after S101 are executed for a user coming into entry gate 400a after user Y.

Next, a case where user Y exits through exit gate 400b will be described.

User Y comes into exit gate 400b (S160). Coming into exit gate 400b by user Y may be detected by, for example, passage management photoelectric sensor 3.

Camera 1b of exit gate 400b captures an image of an area including the face of user Y, and processor 102b of exit face authentication apparatus 21b detects a captured face image from the image captured by camera 1b (S161).

Processor 102b transmits a face search request to face authentication server 200 via communicator 101b (S162). The face search request may include the captured face image.

In S163, processor 202 of face authentication server 200 receives the face search request through communicator 201.

In S164, processor 202 of face authentication server 200 executes face search. For example, processor 202 calculates a score between a candidate face image in authentication information on each entrant included in entrant DB 204 and the captured face image of user Y, and judges that user Y corresponds to the person of the candidate face image having the highest score. Then, processor 202 judges whether or not user Y is a person permitted to pass through exit gate 400b based on the information on judged user Y.

Processor 202 transmits a search result including the judgement result obtained in S164 to exit face authentication apparatus 21b (S165).

Processor 102b of exit face authentication apparatus 21b receives the search result via communicator 101b (S166). Processor 102b judges based on the received search result whether or not the passage of user Y is permitted (S167).

When the passage is permitted (Yes in S167), exit gate 400b opens the door, and notifies information indicating the permission for passage (S168a).

When the passage is not permitted (No at S167), exit gate 400b keeps the door closed, and notifies information indicating that the passage is not permitted (S168b). Then, the process of S161 is executed.

Processor 102b detects the passage of user Y, and transmits, via communicator 101b, a request for registering the passage of user Y through exit gate 400b (S169). The registration request for registering the passage of the user through exit gate 400b may include the identification information (Identification (ID)) of the user who has passed through exit gate 400b, the time at which the user has passed, and the information on the stations or gate where the passage through exit gate 400b took place.

Processor 202 of face authentication server 200 receives, via communicator 201, a passage completion registration request for registration of completion of passage of user Y (S170).

Processor 202 executes an exit completion process for user Y (S171). For example, processor 202 executes a deletion process of deleting the authentication information on user Y from entrant DB 204.

Then, at exit gate 400b, processes subsequent to process S161 are executed for the user coming into exit gate 400b after user Y.

With such processes, the face search for the user passing through exit gate 400b can be performed on the information on a person having entered through entry gate 400a in the authentication information. Thus, the face authentication process can be performed at high speed. That is, the range of the face search for the face of a user who passes through exit gate 400b can be narrowed down to the authentication information managed by entrant DB 204. Thus, it is possible to increase the speed of the face authentication process as compared with the case where the range for the face search is the authentication information managed by face registration DB 203.

In the example of FIG. 5, the example in which the authentication information on the entrant (for example, user Y described above) is stored in entrant DB 204 in the entry completion process (S111 in FIG. 5) has been described, but the present disclosure is not limited to this example. For example, in the entry completion process, processor 202 may set a flag indicative of the entry in the authentication information on user Y in face registration DB 203. In this case, in the face search (S163 in FIG. 5) in accordance with the face search request from processor 102b, processor 202 may calculate the score between the candidate face image of each registrant for which the flag indicating the entry of the registrant is set and the captured face image of user Y in the authentication information in face registration DB 203. That is, in the authentication information in face registration DB 203, the set of pieces of authentication information for which the flag is set may be treated as virtual entrant DB 204. In addition, processor 202 may judge that user Y corresponds to the person of the candidate face image having the highest score. In this case, in the exit completion process (S171 in FIG. 5), processor 202 may cancel (delete) the entry flag set in the authentication information on user Y in face registration DB 203.

As described above, in present Embodiment 1, communicator 201 of face authentication server 200 (one example of the information processing apparatus) obtains a captured image of a person at entry gate 400a who may get on a train (one example of the vehicle) that is to move from entry gate 400a (one example of the first point) to exit gate 400b (one example of the second point). Processor 202 determines a candidate for a person who can reach exit gate 400b by the train (for example, an entrant) based on information on a face image included in the image captured at entry gate 400a. With this configuration, the face search at exit gate 400b can be performed on the person having entered through entry gate 400a. Thus, the processing speed of face image collation for a person passing through a particular region such as the gate can be improved.

Further, in present Embodiment 1, the authentication at entry gate 400a and the authentication at exit gate 400b are performed using the face image. It is thus easier to prevent unauthenticated entry/exit (e.g., impersonation) and it is thus possible to improve security in entry/exit management as compared with the case of using a medium such as an IC card by which it is difficult to identify a possessor.

Embodiment 1 described above has been described in connection with the example in which face authentication server 200 includes entrant DB 204, but the present disclosure is not limited to this. For example, the entrant DB may be provided in exit gate 400b of each station. In this case, face authentication server 200 may generate the entrant information obtained by extracting the authentication information on an entrant from face registration DB 203, and may distribute the entrant information to each station. In this case, exit face authentication apparatus 21b of exit gate 400b may store the distributed entrant information in the entrant DB. In addition, in this case, processor 102b of exit face authentication apparatus 21b may calculate the score between the candidate face image of each of the entrants included in the entrant DB and the captured face image, and judge that the person of the captured face image corresponds to the person of the candidate face image having the highest score. Accordingly, the collation between the face of an exiting person can be completed at exit gate 400b. Thus, further speed-up can be achieved. In this case, exit gates 400b may share information on the exiting person with face authentication server 200 to reflect the deletion process to entrant DB 204.

In above-described Embodiment 1, an apparatus for relaying communication between face authentication server 200 and entry gate 400a or exit gate 400b may exist. For example, a relay server for coordinating communication at entry gate 400a and communication at exit gate 400b may be installed at each station, and communication with network 300 may be performed via the relay server. In this case, the information in entrant DB 204 described above may be distributed from face authentication server 200 to the relay server and held by the relay server. In other words, the relay server may include entrant DB 204 described above. The relay server performs face authentication by using this entrant DB 204, thereby making it easy to synchronize the results of processes such as the deletion of exiting persons between exit gates 400b belonging to the relay server. Further, in this case, exit gate 400b does not need to require remote face authentication server 200 to perform face collation of each exiting person. Thus, an increase in speed of the face authentication process can be expected. Further, in this case, in order that the result of the deletion process at a certain relay server be reflected in the entrant DB of another relay server, the process of periodically synchronizing the entrant DB between face authentication server 200 and the relay servers may be performed.

In present Embodiment 1 described above, the authentication information on the entrant included in entrant DB 204 is used for face authentication at exit gate 400b, but the present disclosure is not limited to this. For example, the authentication information on the entrant may be used to detect suspicious persons, lost children, sick persons, and the like. For example, when the authentication information on entrant Z remains in entrant DB 204 for a certain period of time (for example, one day), processor 202 of face authentication server 200 judges that entrant Z has not exited for the certain period of time. In this case, processor 202 may judge that entrant Z is a suspicious person, a lost child, or a sick person, and may give a warning to an attendant at each station. The warning method for giving the warning is not particularly limited. For example, information indicating the warning may be notified to an information terminal held by the attendant of each station, or the information indicating the warning may be notified to an electronic bulletin board in each station. In addition, information such as age may be used as the authentication information on entrant Z, or age estimation or the like may be performed from the face information to distinguishingly judge a suspicious person, a lost child, or a sick person according to the age of entrant Z. For example, it is conceivable to estimate that entrant Z is likely to be a lost child in case that the entrant is a child, to estimate that entrant Z is likely to be a sick person in case that the entrant is an elderly person, and to estimate that entrant Z is likely to be a suspicious person in the case of another age. In this case, the warning method may be changed according to the judgement result. For example, it is conceivable that the information on entrant Z who is likely to be a lost child is widely broadcast using an electric bulletin board, the information on entrant Z who is likely to be a sick person is notified to a rescue room, and the information on entrant Z who is likely to be a suspicious person is notified to a security guard.

### Embodiment 2

Present Embodiment 2 will be described in connection with an example in which entrants are further narrowed down based on the movement ranges of movement of the entrants who have entered from a certain point will be described. Embodiment 2 described below will be described in connection with one example in which the movement range of movement of an entrant who enters a certain station is used.

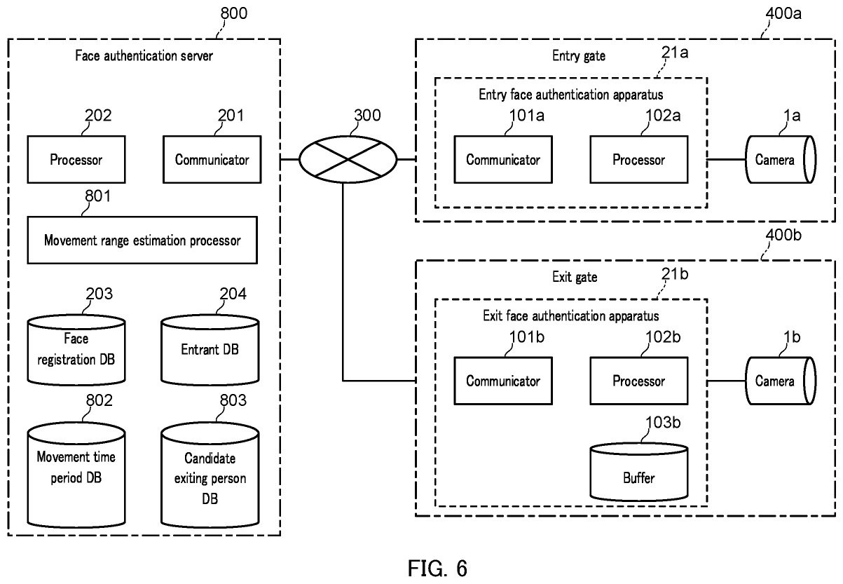

FIG. 6 is a diagram illustrating an exemplary functional configuration of a face authentication server and a gate according to present Embodiment 2. Note that, identical elements between FIG. 4 and FIG. 6 are provided with the same reference numerals and descriptions of such elements may be omitted.

Face authentication server 800 in FIG. 6 includes communicator 201 that communicates with entry face authentication apparatus 21a and exit face authentication apparatus 21b via network 300, face registration DB 203 that manages authentication information, processor 202, movement range estimation processor 801, movement time period DB 802, and candidate exiting person DB 803. Note that, processor 202 and movement range estimation processor 801 may collectively be referred to as “processor.”

Movement range estimation processor 801 performs processing for estimating the movement range of movement of an entrant based on the authentication information on the entrant included in entrant DB 204 and information on the movement time period stored in movement time period DB 802. Based on the estimation result, movement range estimation processor 801 generates information on a candidate exiting person (candidate exiting person information) who may exit through exit gate 400b, and stores the information in candidate exiting person DB 803. The candidate exiting person information may be generated for each exit gate 400b, (e.g., for each station). Further, the candidate exiting person information associated with the stations may be stored in candidate exiting person DB 803. Hereinafter, the candidate exiting person information associated with station A may be abbreviated as candidate exiting person information for station A. The candidate exiting person information for station A is information about a candidate who may exit through exit gate 400b installed in station A. In other words, the candidate exiting person of station A corresponds to those of the entrants excluding a person who cannot exit station A (a person who cannot reach exit gate 400b of station A).

For example, movement range estimation processor 801 estimates the movement range of an entrant based on a station (entry station) where the entrant entered, the time of entry of the entrant, the theoretical movement time period between stations, and the time (for example, the current time) at which the candidate exiting person information is generated. The time of entry of the entrant may be, for example, the time at which camera 1a of entry gate 400a captures an image of the entrant. The station (entry station) where the entrant entered and the time of entry of the entrant may be stored in association with the authentication information on the entrant in entrant DB 204. In addition, movement range estimation processor 801 may estimate the movement range of movement of the entrant at predetermined intervals, and may generate (update) the candidate exiting person information.

The theoretical movement time period taken for movement between stations may be, for example, the minimum movement time period between stations, or may be a time period obtained by adding a margin based on operation information or the like to the minimum movement time period. For example, the minimum movement time period between station A and station B is the minimum time period between the time of entry through entry gate 400a of station A and the time of exit through the exit gate of station B. For example, the minimum movement time period may include the time period taken for movement within the station premises.

The theoretical movement time period may be determined, for example, based on the distance between stations and/or a timetable of the railway network including the stations. For example, the timetable indicates the operation schedule of the train including the time at which the train traveling on the railway network arrives at the station and the time at which the train departs from the station.

In addition, the theoretical movement time period may be dynamically changed (corrected) based on, for example, information on an operating status such as a train delay and holidays. This correction may be correction of the minimum movement time period itself or correction of the margin.

In the following, an example of the estimation of the movement range by movement range estimation processor 801 and an example of the candidate exiting person information will be described.

By way of example, one example of a railway network is taken that includes three stations of station A, station B, and station C, and in which the minimum movement time period between station A and station B is 10 minutes, the minimum movement time period between station A and station C is 20 minutes, and the minimum movement time period between station B and station C is 15 minutes.

In this example, when entrant X enters station A at 9:00 a.m., the earliest time at which entrant X exits station B is 9:10 a.m., and the earliest time at which entrant X exits station C is 9:20 a.m. In this case, it is estimated that the movement range of entrant X (e.g., a station where the entrant can exit) changes after 9:10 a.m. and after 9:20 a.m.

For example, at time before 9:10 a.m., entrant X cannot exit station B and station C. Thus, the candidate exiting person information for station B and station C does not include the authentication information on entrant X during the time after 9:00 a.m. and before 9:10 a.m.

When the time is 9:10 a.m. or later, entrant X can exit station B. Thus, the candidate exiting person information for station B includes the authentication information on entrant X. Even when the time is 9:10 a.m. or later, entrant X cannot exit station C before 9:20 a.m. Thus, the candidate exiting person information for station C does not include the authentication information on entrant X.

Entrant X can exit station B and station C when the time is 9:20 a.m. or later. Thus, the candidate exiting person information for station B and station C includes the authentication information on entrant X. However, when entrant X exits station B before 9:20 a.m., the deletion process is performed on the authentication information on entrant X. Thus, even after 9:20 a.m., the candidate exiting person information for station B and station C does not have to include the authentication information on entrant X.

As described above, whether or not the authentication information on entrant X is included in the candidate exiting person information for each station (for example, station B or station C) is determined based on, for example, the time at which entrant X enters station A, the movement time period taken for movement from station A to each station, and the time at which the candidate exiting person information is determined (for example, the current time).

When entrant X enters at 9 a.m., the candidate exiting person information for station A for the time at or after 9 a.m. may include the authentication information on entrant X.

Next, for example, the relationship between the candidate exiting person information for station A and the time, and the relationship between the candidate exiting person information distributed to station B and the time in the example of the railway network described above will be described.

For example, when the current time is 9:10 a.m., people who can exit station A are entrant b1 who entered station B before 9:00 a.m. that is the current time minus 10 minutes, and entrant c1 who entered station C before 8:50 a.m. that is the current time minus 20 minutes. The candidate exiting person information for station A generated at 9:10 a.m. may include authentication information on entrant b1 and entrant c1. In this case, the authentication information on entrant b2 who entered station B after 9:00 a.m. and entrant c2 who entered station C after 8:50 a.m. are not included in the candidate exiting person information for station A of 9:10 a.m.

Further, for example, when the current time is 9:10 a.m., the people who can exit station B are entrant a3 who entered station A at or before 9:00 a.m. that is the current time minus 10 minutes, and entrant c3 who entered station C before 8:55 a.m. that is the current time minus 15 minutes. The candidate exiting person information for station B of 9:10 a.m. includes authentication information on entrant a3 and entrant c3. In this case, the authentication information on entrant a4 who entered station A after 9:00 a.m. and entrant c4 who entered station C after 8:55 a.m. is not included in the candidate exiting person information for station B for 9:10 a.m.

As is understood, for example, movement range estimation processor 801 determines the candidate exiting person information for each station based on the entry time at which the entrant enters, the theoretical movement time period (e.g., the minimum movement time period) taken for movement between stations, and the time (e.g., the current time) at which the candidate exiting person information is generated (updated).

For example, when first time obtained by subtracting the theoretical movement time period from the current time is at or after second time at which a certain entrant enters, movement range estimation processor 801 determines the authentication information (e.g., face image) on the certain entrant having entered at the second time as the candidate exiting person information.

Note that, movement range estimation processor 801 may use, instead of the current time, the scheduled time for performing face authentication at exit gate 400b. For example, at the time point of the current time, movement range estimation processor 801 may generate candidate exiting person information for each station by performing estimation of the movement range at the scheduled time for performing face authentication after the current time. For example, in an environment where a train arrives at the known scheduled arrival time and it is expectable that many people get off the train, it is preferable that movement range estimation processor 801 sets, in advance, the scheduled time for performing face authentication based on the known scheduled arrival time, and estimates the movement range using the set scheduled time. Specifically, when it is known that the train does not arrive for 10 minutes from the current time, movement range estimation processor 801 may use, as the scheduled time for performing face authentication, the time 10 minutes after the current time. For example, it is possible to start, in advance, the processing which will not be performed until 10 minutes pass, if the current time is used. Accordingly, the processing of estimating the movement range can be started earlier, and therefore the processing can be speeded up. Further, for example, information on the scheduled time for exit face authentication apparatus 21b to perform face authentication may be obtained from exit face authentication apparatus 21b.

Note that candidate exiting person DB 803 does not include the information on the person who has not entered by certain time Tn (for example, the current time), but is to enter after time Tn. Thus, the later the time used as the scheduled time for performing face authentication is than time Tn, the more likely the latest entrant become excluded from candidate exiting person DB 803. For example, in case that movement range estimation processor 801 sets, as the scheduled time for performing face authentication, the time one hour after time Tn, and creates candidate exiting person DB 803 by using the set scheduled time, the information on the person who has not yet entered by time Tn but is to enter within one hour from time Tn is not included in entrant DB 204. Therefore, candidate exiting person DB 803 created based on the information included in entrant DB 204 does not include the information on the person entering within one hour from time Tn.

Thus, in the case of the embodiment using the scheduled time for performing face authentication (hereinafter, time Tx), movement range estimation processor 801 may further perform a complementary process on candidate exiting person DB 803 created at time Tn earlier than time Tx. For example, when the current time transitions from time Tn to time Tx, movement range estimation processor 801 may target the entrant who has entered between time Tn and time Tx to estimate the movement range, so as to determine candidate exiting person information for complement. Then, movement range estimation processor 801 may add (complement) the candidate exiting person information determined at time Tx to candidate exiting person DB 803 created at time Tn. In this case, while the procedure of generating candidate exiting person DB 803 a plurality of times occurs, it is possible to narrow the scope of the entrants to be confirmed for the creation of candidate exiting person DB 803 for complement at the current time (above-mentioned time Tx). It is thus possible to greatly shorten the process time to be performed at the current time.

In the example described above, the complementary process may be performed for the exiting person who has exited through exit gate 400b between time Tn and time Tx. For example, when the current time transitions from time Tn to time Tx, a complementary process may be performed in which the exiting person who has exited through exit gate 400b between time Tn and time Tx is deleted from candidate exiting person DB 803 created at time Tn. Note that the complementary process for deleting the exiting person does not need to be executed.

The above-described example has been described in connection with the complementary process performed in the case where movement range estimation processor 801 uses the scheduled time for performing face authentication at exit gate 400b instead of the current time, but the present disclosure is not limited to this. For example, at the time point of the current time, when performing estimation of the movement range at the current time and generating candidate exiting person DB 803, movement range estimation processor 801 may perform the complementary process for candidate exiting person DB 803 created at a previous time point instead of re-creating candidate exiting person DB 803.

Next, operation of face authentication server 800, entry face authentication apparatus 21a, and exit face authentication apparatus 21b according to present Embodiment 2 will be described.

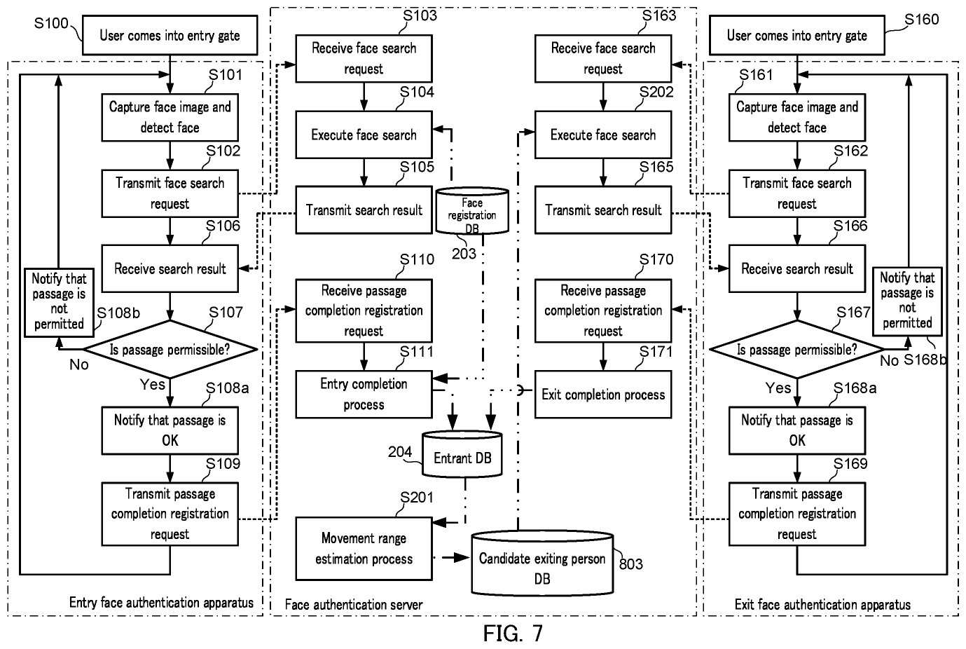

FIG. 7 is a flowchart for explaining an exemplary operation of the face authentication system according to present Embodiment 2. Like FIG. 5, FIG. 7 explains an exemplary operation in connection with entry and exit of certain user Y. Note that, similar processes in FIGS. 5 and 7 are provided with the same reference numerals and descriptions of such components are omitted.

In the flowchart of FIG. 7, a movement range estimation process is added.

Movement range estimation processor 801 of face authentication server 800 performs the movement range estimation process (S201). Movement range estimation processor 801 stores the candidate exiting person information for each station in candidate exiting person DB 803. Candidate exiting person DB 803 is used when processor 202 of face authentication server 800 receives a face search request from exit gate 400b.

Processor 102b transmits a face search request to face authentication server 800 via communicator 101b (S162). The face search request may include a captured face image.

Processor 202 of face authentication server 800 receives the face search request from exit gate 400b via communicator 201 (S163).

Processor 202 of face authentication server 800 executes face search (S202). For example, processor 202 calculates a score between the face image of each of the candidate exiting persons included in candidate exiting person DB 803 for the station including exit gate 400b and the captured face image of user Y, and judges that user Y corresponds to the candidate exiting person of the face image having the highest score. Then, processor 202 judges whether or not user Y is a person permitted to pass through exit gate 400b based on the information on judged user Y.

Processor 202 transmits a search result including the judgement result obtained in S202 to exit face authentication apparatus 21b (S165).

Processor 202 of face authentication server 800 receives, via communicator 201, a passage completion registration request for registration of completion of passage by user Y (S170).

Processor 202 executes an exit completion process for user Y (S171). For example, processor 202 executes a deletion process of deleting the authentication information on user Y from entrant DB 204.

As described above, the movement range estimation process is executed based on the authentication information included in entrant DB 204. Therefore, in the movement range estimation process performed after the authentication information on user Y is deleted from entrant DB 204, the authentication information on user Y is not included in the candidate exiting person information for each station. By deleting a person who has completed exit through exit gate 400b of a certain station (which may be described as “exiting person”) from entrant DB 204, face authentication server 800 can exclude the exiting person from the candidate exiting person information for the station where the exiting person has actually exited and the station where the exiting person has not exited.

As described above, in present Embodiment 2, the face search at exit gate 400b can be targeted at a person who can reach exit gate 400b (a person who can exit through exit gate 400b) among persons who have entered through entry gate 400a. Thus, the processing speed of the face image collation of a person who passes through a particular region such as a gate can be increased. In other words, according to present Embodiment 2, a person who is incapable of reaching exit gate 400b can be excluded from the search target in the face search at exit gate 400b.

Embodiment 2 described above has been described in connection with the example in which face authentication server 800 has candidate exiting person DB 803 for each station, but the present disclosure is not limited to this example. For example, the candidate exiting person DB may be provided in exit gate 400b of each station. In this case, face authentication server 800 may generate the candidate exiting person information for each station and distribute the candidate exiting person information to each station. In this case, exit face authentication apparatus 21b at exit gate 400b may store the distributed candidate exiting person information in the candidate exiting person DB. In addition, in this case, process 102b of exit face authentication apparatus 21b may calculate the score between the candidate face image of each of the candidate exiting persons included in the candidate exiting person DB and the captured face image, and judge that the person of the captured face image corresponds to the candidate exiting person of the face image having the highest score. Accordingly, the collation between the face of an exiting person can be completed at exit gate 400b. Thus, further speed-up can be achieved. In this case, exit gates 400b may share information on the exiting person with face authentication server 800 to reflect the deletion process to entrant DB 204. It should be noted that the process of sharing the exiting person information among exit gates 400b and reflecting the deletion process to the candidate exiting person DB may be performed or does not have to be performed. This is because, the candidate exiting person DB is re-created based on entrant DB 204 as occasion arises, and as long as the candidate exiting person DB is updated frequently enough, the deletion process is reflected in the candidate exiting person DB accordingly if the deletion process is reflected in entrant DB 204.

In Embodiment 2, an apparatus for relaying communication between face authentication server 800 and entry gate 400a or exit gate 400b may exist. For example, a relay server for coordinating communication at entry gate 400a and communication at exit gate 400b may be installed at each station, and communication with network 300 may be performed via the relay server. In this case, the information in entrant DB 204 described above may be distributed to the relay server. It is thus possible to easily synchronize the exit process among exit gates 400b belonging to the relay server. Further, in this case, exit gate 400b does not need to require remote face authentication server 800 to perform face collation of each exiting person. Thus, an increase in speed of the face authentication process can be expected. Further, in this case, synchronization of the entrant DB between face authentication server 800 and the relay server may be periodically performed in order to reflect the deletion process performed at exit gate 400b belonging to a certain relay server. For the same reason as described above, the process of reflecting the deletion process to the candidate exiting person DB held by each relay server may be performed or does not have to be performed.

When the candidate exiting person DB is provided at exit gate 400b, face authentication server 800 may set the margin based on the feedback information from exit face authentication apparatus 21b of exit gate 400b. Face authentication server 800 may generate the candidate exiting person information based on the theoretical movement time period including the set margin. For example, the feedback information may include information about the capacity of the candidate exiting person DB of exit gate 400b and/or information about an error of collation at exit gate 400b. Face authentication server 800 may dynamically set a margin for each station based on the feedback information. Generally, the larger the margin is, the larger the size of the candidate exiting person DB becomes. Meanwhile, the information on the face to be collated increases. Thus, the face collation is less likely to fail. Therefore, for example, when the capacity of buffer 103b is small, the size of the candidate exiting person DB may be reduced by reducing the margin. Further, as the number of failures in face authentication increases, the margin may be increased to improve the accuracy of face collation.

Present Embodiment 2 described above has been described in connection with the example in which the authentication information on the candidate exiting person included in candidate exiting person DB 803 is used for face authentication at exit gate 400b, but the present disclosure is not limited to this. For example, the authentication information on the candidate exiting person may be used to detect suspicious persons, lost children, sick persons, and the like. For example, when the authentication information on candidate exiting person Z remains in candidate exiting person DB 803 for a certain period of time (for example, one day), processor 202 of face authentication server 800 judges that candidate exiting person Z has not exited for the certain period of time. In this case, processor 202 may judge that candidate exiting person Z is a suspicious person, a lost child, or a sick person, and may give a warning to an attendant at each station. The warning method for giving the warning is not particularly limited. For example, information indicating the warning may be notified to an information terminal held by the attendant of each station, or the information indicating the warning may be notified to an electronic bulletin board in each station. In addition, information such as age may be used as the authentication information on entrant Z, or age estimation or the like may be performed from the face information to distinguishingly judge a suspicious person, a lost child, or a sick person according to the age of entrant Z. For example, it is conceivable to estimate that entrant Z is likely to be a lost child in case that the entrant is a child, entrant Z is likely to be a sick person in case that the entrant is an elderly person, and entrant Z is likely to be a suspicious person in the case of another age. In this case, the warning method may be changed according to the judgement result. For example, it is conceivable that the information on entrant Z who is a lost child is widely broadcast using an electric bulletin board, the information on entrant Z who is a sick person is notified to a rescue room, and the information on entrant Z who is a suspicious person is notified to a security guard.

In Embodiment 2 described above, the search order of the candidate exiting person in the candidate exiting person information may be changed. For example, when the minimum movement time period between station A and station B is 10 minutes, it may be assumed that entrant X who entered station A is most likely to exit station B at time T1 obtained by adding 10 minutes and a margin to the entry time. In this case, the search order of entrant X may be lowered in the candidate exiting person information for station B because the possibility that entrant X exits station B decreases with the elapse of time period from time T1. When the time period elapsed from time T1 is extremely long, entrant X may be deleted from entrant DB 204 or candidate exiting person DB 803. Exit after the elapse of 5, 6, or more hours since entry may, for example, be rejected in the currently performed management on entry/exit using a transportation IC card. The same process can be realized by deleting entrant X from entrant DB 204 or candidate exiting person DB 803 also in present Embodiment 2.

Further, in Embodiment 2 described above, information different from that in the above-described example may be used for the estimation of the movement range of the entrant. For example, the frequency of station use of the entrant and/or commuter pass information on the entrant may be used to estimate the movement range of movement of the entrant. The frequency of station use of the entrant and/or the commuter pass information on the entrant correspond to, for example, the frequency of movement from a certain entry station to a certain exit station. For example, in the case where the frequency at which entrant X exits station B is higher than the frequency at which entrant X exits other stations than station B, the authentication information on entrant X may be set relatively higher in priority for the face search in the candidate exiting person information for station B. In this case, in the candidate exiting person information for other stations than station B, the authentication information on entrant X may be set relatively lower in priority for the face search. By setting the order according to the frequency of use or the like in the candidate exiting person information, an entrant who frequently uses the station is set as a search target earlier in the face search process. Thus, the face search process can be speeded up.

Further, above-described Embodiment 2 has been described in connection with the example in which the theoretical movement time period for movement between stations is used in the estimation of the movement range of the entrant, but a margin for each user may be added to the theoretical movement time period for movement between stations. For example, the time of stay of a user in the station premises may be added as the margin. In addition, at least one of the theoretical movement time period and the margin may be set based on actual measurement values of actual behaviors of the entrant and the exiting person. A difference between the time listed in a timetable of a train or the like and the actual time of entry and exit can be measured from a difference between the time of passage through the entry gate and the time of passage through the exit gate.

In addition, a different value for each time zone may be used for at least one of the theoretical movement time period and the margin. For example, in the time zone in which a commuting rush occurs, congestion in the station premises as compared with other time zones is expected. Thus, at least one of the theoretical movement time period and the margin that is set longer than in other time zones is likely to match an actual usage environment.

In each of the above-described embodiments, the information used for face search and face authentication, and information transmitted and received between apparatuses may be a face image itself or a feature value extracted from the face image. Here, as one example of the feature value, a color, a shape, a brightness distribution of the face, and the like are considered. The feature value may be a feature value generated by more complicated processing used in the field of machine learning. By using the feature value, it is possible to reduce the size of information exchanged between the face authentication server and the exit face authentication apparatus. In addition, since the influence of parameters that are easily changed in the real environment is suppressed depending on the feature value used, robust face authentication becomes possible.

Although each of the above embodiments has been described by taking a railway network as an example, the present disclosure is not limited thereto. For example, the present disclosure may be applied to transportation systems such as route buses, ships, and air routes.

Also, the present disclosure may be applied to entry/exit management on facilities such as buildings and shopping malls having a plurality of entrances. The plurality of entrances may include, for example, a gate (e.g., a main gate) for managing entry/exit into and from a facility and a gate for managing entry/exit into and from a particular room within the facility.

In this case, for example, authentication information on a user who enters through a certain entry gate in the facility is stored in the entrant DB. In this case, the authentication information in the entrant DB is used for the face collation in the case where the user exits through a certain exit gate in the facility. The face search for the user who passes through the exit gate can be performed on the information on people who have entered through the entry gate in the authentication information. Thus, the face authentication process can be performed at high speed.

For example, according to the present disclosure, face authentication processing can be performed at high speed in management of entry and exit performed until a user of a building having exited a particular room of the building exits the building.

Further, each of the above-mentioned embodiments aims to perform face authentication of an exiting person, but the present disclosure is not limited to this. In the case where an entrant who has entered a certain particular region further intends to enter a partial region in the particular region available for a part of entrants, the same idea can be applied to face authentication at the entry into the partial region. Specifically, the face authentication processing can be performed at high speed in management to be performed until a user who has passed through a main gate of a building (one example of the particular region) and entered the building reaches a particular story or a particular room (for example, an office or conference room used by the user) (one example of the partial region).

When the present disclosure is applied to a facility such as a building and a shopping mall having a plurality of entrances, the entrants may be further narrowed down based on the movement ranges of the entrants within the facility as in above-described Embodiment 2. In this case, information equivalent to the candidate exiting person DB (e.g., information on a candidate entrant in the partial region) may be used not only for narrowing down the exiting persons in the facility but also for narrowing down the entrants who intend to enter the partial region in the facility.

Further, in each of the above-described embodiments, the deletion process is performed when the passage of a user is detected, but the present invention is not limited to this. In the case where passage management photoelectric sensor 3 or another passage detection device is not mounted, the deletion process may be performed at the time point when the face collation of the user succeeds.

In each of the above-described embodiments, the entrant DB is created by extracting the authentication information on the entrant from the face registration DB, but the present invention is not limited thereto. For the purpose of surely managing whether or not the entrant has exited, the information on the face image extracted from the image captured at the time of entry may be directly registered in the entrant DB. Further, in this case, when it is not necessary to authenticate the entrant at the time of entry, the face registration DB itself may be omitted.

Further, in each of the above-described embodiments, when face authentication of the exiting person is not successful even when the entrant DB or the candidate exiting person DB is used, the passage is kept restrained. However, the present invention is not limited to this. For example, additional face collation may be performed using the face registration DB. Accordingly, even when the creation of the entrant DB or the candidate exiting person DB fails, the additional face collation can be performed. Although the face collation using the face registration DB takes time, the face registration DB is rarely used in the present variation. Thus, the face collation is speeded up on average as compared with the case where the face collation is performed using the face registration DB every time.

Further, in each of the above-described embodiments, the types of information stored in the entrant DB or the candidate exiting person DB may be different from the types of information used in obtaining the collation result. For example, it is conceivable that the feature value of a face contour is used to create each of the DBs, and the feature values of face parts are used to obtain the collation result. The accuracy can be expected to be improved by performing processing of narrowing down and processing of obtaining a collation result using different information.

Unlike the above, the same type of information may be used as information for creating each of the DBs and information for obtaining the collation result. Accordingly, the evaluation is performed from the same viewpoint in the narrowing-down and face authentication processing. It is thus possible to suppress the occurrence of a deviation in the determination result. As a result, the frequency of the request to the face authentication server taking place due to the failure of face authentication can be reduced. Thus, the face authentication processing can be speeded up.

Further, in the above embodiment, the face image included in the entrant DB or the candidate exiting person DB does not have to be an image itself but may be a feature value thereof. The “face image information” is a concept including the face image itself and the feature value of the face image. In particular, in a configuration in which the entrant DB or the candidate exiting person DB is transmitted from the face authentication server to the exit face authentication apparatus, database including the feature value can suppress the communication amount. However, the face image itself may be used as the entrant DB or the candidate exiting person DB in a situation where the size of the entrant DB or the candidate exiting person DB hardly affects the communication amount, for example, in a case where face collation of an exiting person is performed in the face authentication server.

In each of the above-described embodiments, gate 400 includes opening/closing door mechanism 4, but a means (restrainer) for restraining the movement of a person when the face collation fails is not limited to this. For example, psychological restraining mechanisms such as sirens and/or alarms may be employed. In addition, a mechanism for indirectly restraining movement by sending a notification to a guardsman and/or a robot or the like disposed nearby without sending the notification to a person who intends to pass through the gate may be employed. It should be noted that the time taken after the failure of the face collation until the restraint differs depending on which restrainer is adopted. Whichever means is used, speeding up the face collation is similarly useful to obtain the result of the face collation before the person reaches the restrainer.

In other words, the means (restrainer) for restraining the movement of a person when face collation fails is not limited to the example of physically restraining (blocking) the movement of the person, such as by opening/closing door mechanism 4 of gate 400 disposed in the middle of a person's movement path. For example, a particular point (or range) is set for gate 400, and gate 400 may restrain the movement of a person from upstream of a particular point to downstream of the particular point in the direction of movement of the person. In this case, the restrainer may be a siren, an alarm, or the like, as described above, or may be a notification to a guardsman, a robot, or the like.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

In addition, in recent years, in Internet of Things (IoT) technology, Cyber Physical Systems (CPS), which is a new concept of creating new added value by information collaboration between physical space and cyberspace, has been attracting attention. Also in the above embodiments, this CPS concept can be adopted. That is, as a basic configuration of the CPS, for example, an edge server disposed in the physical space and a cloud server disposed in the cyberspace can be connected via a network, and processing can be distributedly performed by processors mounted on both of the servers. Here, it is preferable that processed data generated in the edge server or the cloud server be generated on a standardized platform, and by using such a standardized platform, it is possible to improve efficiency in building a system including various sensor groups and/or IoT application software.

The communication may include exchanging data through, for example, a cellular system, a wireless LAN system, a satellite system, etc., and various combinations thereof

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Moreover, any combination of features of the above-mentioned embodiments may be made without departing from the spirit of the disclosure.

While concrete examples of the present invention have been described in detail above, those examples are mere examples and do not limit the scope of the appended claims. The techniques disclosed in the scope of the appended claims include various modifications and variations of the concrete examples exemplified above.

The disclosure of Japanese Patent Application No. 2020-030493, filed on Feb. 26, 2020, including the specification, drawings and abstract is incorporated herein by reference in its entirety.

### INDUSTRIAL APPLICABILITY

One exemplary embodiment of the present disclosure is suitable for face authentication systems.

### REFERENCE SIGNS LIST

1, 1a, 1b Camera

2 QR code reader

3 Passage management photoelectric sensor

4 Opening/closing door mechanism

5 Entry guide indicator

6 Passage guide LED

7 Guide-displaying display

8 Speaker

9 Interface board

10 Interface driver

20 Gate control apparatus

21a Entry face authentication apparatus

21b Exit face authentication apparatus

30 Network hub

100 Face authentication system

101, 201 Communicator

102, 202 Processor

103b Buffer

200, 800 Face authentication server

203 Face registration DB

204 Entrant DB

300 Network

400 Gate

400a Entry gate

400b Exit gate

601, 701 Processor

602, 702 Memory

603, 703 Input/output interface

604, 704 Bus

801 Movement range estimation processor

802 Movement time period DB

803 Candidate exiting person DB

1. An information processing apparatus, comprising:
an obtainer that obtains an image of a person who is able to board a vehicle that is to move from a first point to a second point, the image being captured at the first point; and
a processor that determines a candidate for a person who is capable of reaching the second point by the vehicle and who is subjected to face collation at the second point, the determining being based on information on a face image included in the image.

2. The information processing apparatus according to claim 1, wherein
based on time information about time at which the face image is captured and information on movement time period for movement by the vehicle from the first point to the second point, the processor excludes, from the candidate, a person who is incapable of reaching the second point by the vehicle by predetermined time.

3. The information processing apparatus according to claim 2, wherein
based on information on a frequency of use of at least one of the first point and the second point by the person, the processor preferentially determines, as the candidate, a person for whom the frequency of use is high.

4. The information processing apparatus according to claim 2, wherein
the processor estimates the movement time period based on information about an operation schedule of the vehicle.

5. The information processing apparatus according to claim 4, wherein:
the obtainer obtains information indicating an operation status of the vehicle, and based on the information indicating the operation status, the processor corrects the movement time period estimated.

6. The information processing apparatus according to claim 2, wherein
the processor estimates the movement time period based on information on a distance between the first point and the second point.

7. The information processing apparatus according to claim 2, wherein:
the predetermined time is current time, and
when first time obtained by subtracting the movement time period from the current time is at or after second time at which the face image is captured, the processor determines, as the candidate, a person of the face image captured at the second time.

8. The information processing apparatus according to claim 7, wherein
the processor updates the candidate per regular time period.

9. The information processing apparatus according to claim 2, wherein:
the predetermined time is scheduled time for performing the face collation,
the obtainer obtains, from the second point, information indicating the scheduled time for performing the face collation, and
when first time obtained by subtracting the movement time period from the scheduled time is at or after second time at which the face image is captured, the processor determines, as the candidate, a person of the face image captured at the second time.

10. The information processing apparatus according to claim 9, wherein:
the obtainer further obtains an image captured at the first point between current time and the scheduled time, and
based on information on a face image included in the image captured at the first point between the current time and the scheduled time, the processor further determines a person capable of reaching the second point by the vehicle, and adds the person to the candidate.

11. The information processing apparatus according to claim 1, wherein
based on the information on the face image included in the image captured at the first point, the processor narrows down information on a face image of a person using the vehicle, to determine the candidate capable of reaching the second point by the vehicle.

12. The information processing apparatus according to claim 1, wherein:
there are a plurality of the first points from which the second point is reachable by the vehicle, and
the obtainer obtains an image captured at each of the plurality of first points.

13. A face authentication system, comprising:
a camera that, at a first point, captures an image of a person who is able to board a vehicle that is to move from the first point to a second point; and
an information processing apparatus that obtains the image captured by the camera, and determines a candidate for a person who is capable of reaching the second point by the vehicle and who is subjected to face collation at the second point, the determining being based on information on a face image included in the image.

14. An information processing method, comprising:
obtaining an image of a person who is able to board a vehicle that is to move from a first point to a second point, the image being captured at the first point; and
determining a candidate for a person who is capable of reaching the second point by the vehicle and who is subjected to face collation at the second point, the determining being based on information on a face image included in the image.
